(19) United States
(12) Patent Application Publication
(10) Pub. No.: US 2015/0063349 A1
(43) Pub. Date: Mar. 5, 2015

(54) Programmable switching engine with storage, analytic and processing capabilities

(71) Applicants: SHAHAB ARDALAN, San Jose, CA (US); Mona Mojdeh, Menlo Park, CA (US)

(72) Inventors: SHAHAB ARDALAN, San Jose, CA (US); Mona Mojdeh, Menlo Park, CA (US)

(21) Appl. No.: 14/010,834

(22) Filed: Aug. 27, 2013

(51) Int. Cl. H04L 12/721; H04L 12/851; H04L 12/933; H04L 12/771

(52) U.S. Cl. CPC H04L 45/14; H04L 45/56; H04L 47/2483; H04L 49/103
USPC 370/381

(57) ABSTRACT

An improvement to the prior-art extends an intelligent solution beyond simple IP packet switching. It intersects with computing, analytics, storage and performs delivery diversity in an efficient intelligent manner. A flexible programmable network is enabled that can store, time shift, deliver, process, analyze, map, optimize and switch flows at hardware speed. Multi-layer functions are enabled in the same node by scaling for diversified data delivery, scheduling, storing, and processing at much lower cost to enable multi-dimensional optimization options and time shift delivery, protocol optimization, traffic profiling, load balancing, and traffic classification and traffic engineering. An integrated high performance flexible switching fabric has integrated computing, memory storage, programmable control, integrated self-organizing flow control and switching.

### CROSS-REFERENCE TO RELATED APPLICATIONS

This application claims the benefit of U.S. Provisional Patent Application No. 61/694,769, filed on Aug. 30, 2012, which is incorporated in its entirety by reference.

### BACKGROUND OF THE INVENTION

Today's networks are limited in providing optimized delivery options for non-real-time traffic flows and are very rigid when it comes to network management options for diversified traffic flows, such as object switching, API switching, and trigger and event based delivery. Today's networks are designed to support peak traffic throughput requirement and are not able to handle peak traffic effectively. They also cannot handle congestion effectively, and therefore are typically not resource optimized.

Existing switch fabrics are limited in flexible policy driven delivery and content analysis and processing options. Managing diversified traffic flows, such as Machine-to-Machine, big data, objects, and APIs are not properly supported in current networks. Current networks are also typically overhead intensive due to additional hardware and software error protection mechanisms in place, such as RAID, wireless channel data redundancy and protocol retransmissions.

Current networks are also typically limited in intelligence to perform analytical computing and routing for pre-processing, load balancing and flow optimization. Existing networks are often not capable of data traffic and signaling reduction due to lack of integrated real time data content processing. Limited network support exists for emergency signaling and emergency traffic flows. Limited support is provided for traffic forecasting, machine learning, data mining, and behavioral driven network adaptation. The data transmission over existing network is also typically not error free; therefore the data retransmission rates are often too high for emerging networks. The existing data transmission over networks also has limitations for multi-layer data transmission.

The exponential growth of the Internet has made it a popular delivery medium for heterogeneous data flows. Such heterogeneity has caused an increasing demand for bandwidth. As a result, equipment vendors often race to build larger and faster switches with versatile capabilities, such as defining data flows using software, to move more traffic efficiently. However, the complexity of a switch cannot grow infinitely. It is limited by physical space, power consumption, and design complexity, to name a few factors. Furthermore, switches with higher and versatile capability are usually more complex and expensive.

Software-defined flow is a new paradigm in data communication networks. In this regard, any network supporting software-defined flows can be referred to as a software-defined network. An example of a software-defined network is an OpenFlow network, wherein a network administrator can configure how a switch behaves based on data flows that can be defined across different layers of network protocols. A software-defined network separates the intelligence needed for controlling individual network devices (e.g., routers and switches) and offloads the control mechanism to a remote controller device, which is often a stand-alone server or end device. Therefore, a software-defined network provides complete control and flexibility in managing data flow in the network.

While support for software-defined flows brings many desirable features to networks, certain issues remain unsolved in management of flow definitions. For example, because software-defined networks redefine traditional data flow management, the coexistence of a software-defined network with current network architecture can be challenging.

In addition, today's networks are typically running independent computing and storage entities. Therefore, there are typically no collaborative functional methods that are extended between them. In addition, a process synch and coordinated effort between networks, computing, and storage cannot be provided in the today's network platform.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 shows the elements of the new intelligent data delivery engine in accordance with certain embodiments.

FIG. 2 shows a main functional building blocks of the invention in accordance with certain embodiments.

FIG. 3 illustrates an example of flow transition with respect to the system functional blocks in accordance with certain embodiments.

FIG. 4 shows the building blocks of the invention in accordance with certain embodiments.

FIG. 5 shows the building diagram of one implementation of the invention in accordance with certain embodiments.

FIG. 6 illustrates an example of a flow diagram showing how different blocks in add-on implementation work with each other and how the flows pass through this system.

FIG. 7 shows the building diagram of another implementation of the invention in accordance with certain embodiments, namely an intelligent switch implementation of on Open Flow concept.

FIG. 8 illustrates an exemplary open API software platform in accordance with certain embodiments of the invention.

### SUMMARY

In accordance with one or more embodiments, a novel self-organizing data processor and delivery fabric facilitates switching, routing and data delivery diversity at multi-disciplinary levels and provides pre-delivery content processing. It enables adaptive flow handling, where flows are characterized and switched at multi-discipline policies on-the-fly for analytics, computing and storage delivery. It enables packet/trigger/API/object/event/policy routing, switching, protocol, data and signaling optimization, aggregation, and mapping of functions at the packet, object, block, and file levels. An exemplary embodiment of the latter includes: a processor configured to execute a set of computer-readable instructions; and a memory component coupled to the switching fabrics and configured to store the set data flows in the integrated memory with the switching fabric until at least one algorithm or data delivery “labeled marking” is analyzed and/or data content is processed, for determining the delivery methodology, including format, time, location, and others, to assist scheduling algorithms.

In accordance with certain embodiments, the memory integrated component of the switching fabric is further configured to store a set of delay insensitive, near real-time, and real-time data, with at least one algorithm for determining scheduling of data being stored for delivery, and dependent on the set of triggers, events, and policies based on a delivery “labeled marking.” A delivery “labeled marking” may further contain delivery function, instruction to the fabric, etc.

In accordance with certain embodiments, the data processing element will take place on data stored in memory to perform functions of the proposed system, including packet routing, switching, protocol, data and signaling optimization, aggregation, and mapping functions, at the packet, object, block, and file levels. Specific processing functions, such as those specific to cloud servers are provided, and described here, as pre-delivery data processing functions.

In accordance with certain embodiments, the memory is an integral part of the switching fabric for the purpose of object switching, object storing and data delivery diversity, based on multi-dimensional delivery “labeled marking,” where the memory is tightly coupled with the switching fabric for optimum performance gain.

In accordance with certain embodiments, the fabric attached memory is partitioned in such a way for optimum delay IOP, at the block, file, object, or packet associated with different data types. This includes sensor data with variant QOS, with multi-dimensional delivery “labeled marking” for specific preferences, corresponding to the end user, network and content data delivery polices.

In accordance with certain embodiments, the classification probe, packet processor and content processor are used to extract objects and subsets of objects from the raw packets. Classified objects will be carried out, based on multi-dimensional delivery key performance metrics, including network, users, and the content provider's conditions.

In accordance with certain embodiments, a set of “labeled marking” flows is generated based on classification output and network conditions, including QOS, and with specific preferences corresponding to the end user, network and content data, by the data delivery engine, which are used to separate packets from objects, and objects from control sensors, or store certain data flows for further processing or data delivery diversity with special preferences corresponding to an enterprise.

In accordance with certain embodiments, the set of switching functions may include data store functions at the integrated memory fabric, until appropriate thresholds are met for appropriate triggering for switching, and data delivery over the fabric ports.

In accordance with certain embodiments, a packet/flow processor generates “labeled marking” based on network, users, and content provider's policies.

In accordance with certain embodiments, a set of switching methodology beyond packet switching includes API, object, file and block switching, at network conditions at a given time. The latter further comprises receiving data and converting the data into different formats for switching at desired levels (packet, object, block, file, API). It also further comprises a system enabling customized knowledge switching, where the knowledge is defined by the policy function.

In accordance with certain embodiments, the interface component of a switching fabric is configured to receive packets, objects, files, blocks and utilize the fabric memory for further translation to another switching method, or simply to keep the same switching method, with consideration for delivery being tied to a “labeled marking” label.

In accordance with certain embodiments, a method for facilitating management of elastic data in a cloud/enterprise or wireless environment, is provided. It includes providing a degree of elasticity to eliminate unnecessary delivery of data over network infrastructure and scheduling a transmission of traffic entities, including in and out of memory stored fabric, with a particular degree of QOS, which also includes data delivery conditions, such as receiver triggers, events, and/or network congestion levels corresponding to the particular flow.

In accordance with certain embodiments, further included is ascertaining a set of tolerance data, with a scheduling step being at least partially dependent on network condition, protocol, servers, load balancing, shaping, and traffic pacing.

In accordance with certain embodiments, further included is an inter/intra interaction communication interface, with enterprise, and other proposed system and/or Internet nodes, to acquire conditional synch delivery to form a self-organized, distributed, intelligent and collaborative delivery fabric.

In accordance with certain embodiments, an inter/intra interaction communication includes signaling, control, system conditions, states, server loads, memory thresholds and content providers. Here, further included are ascertaining data delivery options mapping each of the flows to an appropriate lookup table, known as fabric key performance indicators.

In accordance with certain embodiments, the fabric key performance indicators are utilized to make scheduling and content processing decisions. Further included are the scheduler functioning at resource blocks associated with the next switching hub corresponding to a similar or with reduced functions, with respect to object, block, API, and packet switching level capabilities.

In accordance with certain embodiments, the assembling step further includes characterizing each of the delivered traffic entities, where the characteristic of switching depends on schedulers directives and look up policy tables.

In accordance with certain embodiments, further included is transmitting data in and out of the fabric, which includes instructions for next hub delivery, indicating at least one port or memory location for the data forwarding.

In accordance with certain embodiments, further included is a self-organizing emergency response system, through enablement of an elastic buffer, for store and forward function, plus received broadcasting of emergency signals at the state of emergency. Here, the potential network relationships are at high risk or may be totally lost, mesh and the like.

In accordance with certain embodiments, the flows within each such system are power and resource optimized through state transitions. Certain or all the flows are controlled by control units through state transitions, such as idle, connected, wait state, pending, etc. This enables full or partial functioning, including processing, mapping, routing, storing, and the like.

### DETAILED DESCRIPTION

Approaches prior to the present embodiments are cost prohibitive and capital intensive in supporting future data flow service demands. Existing solutions introduce additional delay and impact end-user quality of experience (QoE), waste plentiful resources and are not scalable for future applications, including M2M, education, sensors, big data, and video. Solutions prior to the present embodiments are not able to distinguish and treat diversified traffic flows and behaviors to meet the expected user's key performance indicators and optimization demands. Previous solutions are inflexible, resource intensive and limited in delivery functionality. Existing networks are rigid and not programmable at the core network level. They also cannot perform simultaneous content processing, time delivery adjustment, switching and resource management in an efficient way.

Certain embodiments of this invention provide an improvement to the prior-art by extending intelligent solution beyond simple IP packet switching. They intersect with computing, analytics and storage, and perform delivery diversity in an efficient, intelligent manner. Certain embodiments of this invention enable a flexible, programmable network that can store, time shift, deliver, process, analyze, map, optimize and switch flows at hardware speed. Certain embodiments of this invention enable multi-layer functions in the same node by scaling for diversified data delivery, scheduling, storing, and processing at much lower cost to enable multi-dimensional optimization options and time shift delivery, protocol optimization, traffic profiling, load balancing and traffic classification and traffic engineering.

Certain embodiments provide an integrated high performance, flexible switching fabric with integrated computing, memory storage, programmable control, integrated self-organizing flow control and switching. They may add two more dimensions to the current data delivery mechanism along with an open API software platform that creates a new, intelligent data delivery engine.

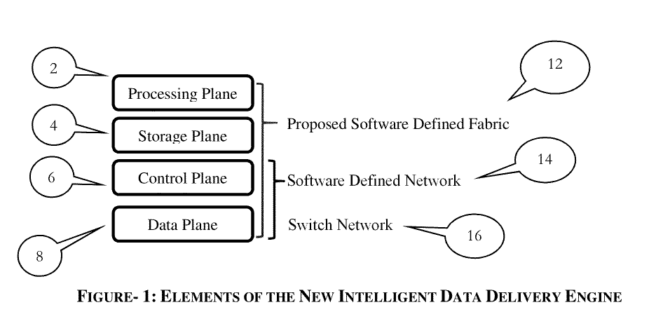

The foregoing is illustrated with reference to FIG. 1. In particular, FIG. 1 illustrates elements of a new, intelligent data delivery engine 100. Elements 100 includes a processing plane 2, storage plane 4, control plane 6 and data plane 8. Switch network 16 and software defined network 14 may function at the control plane 6 and/or data plane 8. A proposed software defined fabric 12 may function at all of the planes, namely processing plane 2, storage plane 4, control plane 6 and data plane 8.

Through the environment of elements 100, innovative flow management functions are enabled that are applied to traffic flows at the switch/routers. Flows are classified for specific delivery based on adaptive policies that are derived from unique triggering flow options. The integrated intelligent memory/storage with the switching fabric enables diversified data delivery for various traffic flows. Such flows extend themselves to overall optimization of the networks, cloud, application and protocols. The innovative solution of certain embodiments calls for flow classifications that are tied to user policies/behavior, traffic flow behavior, triggers and events. In accordance with certain embodiments, programmable interfaces are enabled with delivery options, such as object, analytics, switching, content mapping, forecasting, data mining, processing and delivering. In certain embodiments, the delivery engine is also tied to specific policies, such as location, time of day, social events, content type and forecast.

Certain embodiments enable multi-dimensional data manipulation and delivery at or with collaboration of storing, computing, time delivery adjustment and routing functions.

Certain embodiments of the invention collectively perform traffic profiling, flow characterization, and switching at IP, object, and API boundaries.

Certain embodiments of the invention fully support an innovative trigger based delivery in support of policy dynamics and optimization demands (e.g., protocol, network, computing).

Certain embodiments of the invention are a front-end to enterprise cloud and platform for the purpose of overall data and signaling traffic reduction.

Certain embodiments provide storage, analytics, processing, forecast, data mining, machine learning and routing functions according to a set of dynamic controls enabled by such embodiments of this invention.

Certain embodiments of this invention enable flow optimization in various resources, including mobility resources, cloud, protocols, servers, emergency traffic and signals.

In certain embodiments, an innovative flow state transition method is introduced at the core of this system, where certain flows may transit to idle state with minimal power usage until a trigger pushes the flow to other states.

Certain embodiments of the invention enable a self-organizing switching system, in which an inventive switch can control and connect to other switches of various types as well as traditional ones. In addition, a self-organizing system may also place the switch in an idle state fully or partially with minimal power usage until a trigger pushes it to other states.

Certain embodiments of this invention enable next-generation networks with higher bandwidth, increased availability, scalability, fault tolerance, and longer distance delivery at much lower capital rates. The solution performs fabric arbitration and intelligent data storage/release.

Certain embodiments of this invention reduce the retransmission rate by establishing a direct link between nodes and receivers. In addition, it reduces the network delay, including TCP optimization (e.g., TCP delay) due to the presence of the data at the localized/distributed storage, and breaking the long TCP/IP links to shorter node-to-node links.

Certain embodiments of this invention are able to transform simple single layer data transmissions approach to a more efficient multi-layer data transmissions approach via innovative storing and processing capability of an inventive system.

Certain embodiments of this invention furthermore expand and categorize networking actions (e.g., such as delivery, congestion, flow/traffic engineering) to user-based, application-based, trigger/event-based, etc. An exemplary embodiment of this invention includes spam filtering/blocking.

Certain embodiments of this invention enable a self-organizing methodology, at the network level, and/or including the switching level, in which the invented system can control and connect to other switches and systems of kind or existing switches, such as open-flow ones, for the purpose of cross optimizations. In addition, the self-organizing system may also place the switch in various states, such as an idle state, which performs power and resource optimization according to the state transitions of the system. With this approach, the system can automatically turn certain functional elements off or execute with minimal resources and power, awaiting a proper trigger.

Certain embodiments of this invention enable time-shifting, where route tables for switches will be extended to support delay, and timers, where the foregoing can be used as a mechanism to delay a packet according to these timers.

Certain embodiments of this invention contain the following functional blocks: (i) an elasticity probe, (ii) a flow characterization probe/flow classifier, (iii) a packet processor, (iv) a content Processor, (v) a memory/storage, (vi) a cross-connect, and/or (vii) a control unit.

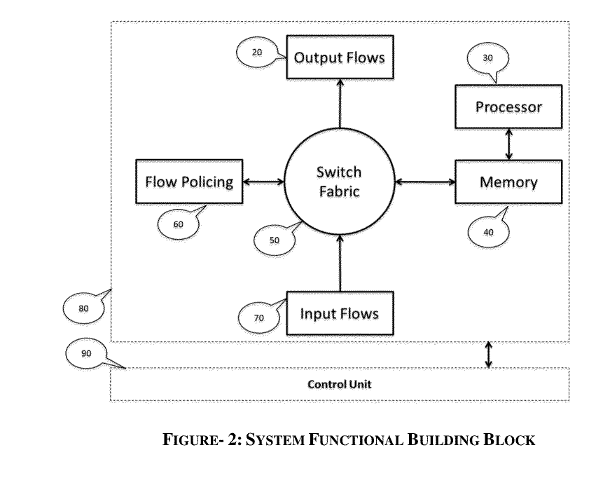

FIG. 2 shows system function building blocks 200 of certain embodiments of the invention and the relationship between such functional blocks and components. As shown, there is communication of output flows 20, memory 40 (and corresponding processor 30), input flows 70 and flow policing 60, with a switch fabric 50, the system being collectively referenced as item 80. The foregoing may also communicate with control unit 90.

In particular, in certain embodiments of the invention, a switch fabric 50 passes input flows 70 through the system according to flow policing. The flows are passed through the fabric to output flows 20 or they are stored and processed, via memory 40 and processor 30, according to network, user and operator flow policing.

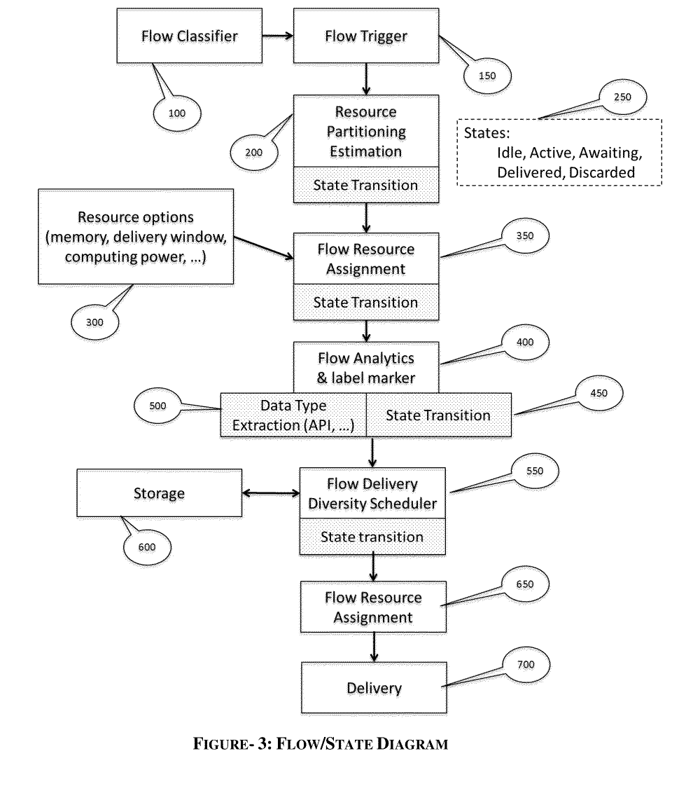

FIG. 3 illustrates flow state diagram 300, which is an exemplary flow transition with respect to the system functional blocks. The following flows and states are illustrated: flow classifier 100, flow trigger 150, certain states (Idle, Active, Awaiting, Delivered and Discarded), resource partitioning estimation and state transition 200, resource options (memory, delivery window, computing power, etc.) 300, flow resource assignment and state transition 350, flow analytics and label marker 400, data type extraction (API, etc.) 500, state transition 450, storage 600, flow delivery diversity scheduler and state transition 550, flow resource assignment 650 and delivery 700.

In one example flow, the states are changed between the following states: Idle, Active, Awaiting, Delivered, Discarded 250, which represents the treatment of the flows as they moved through the system.

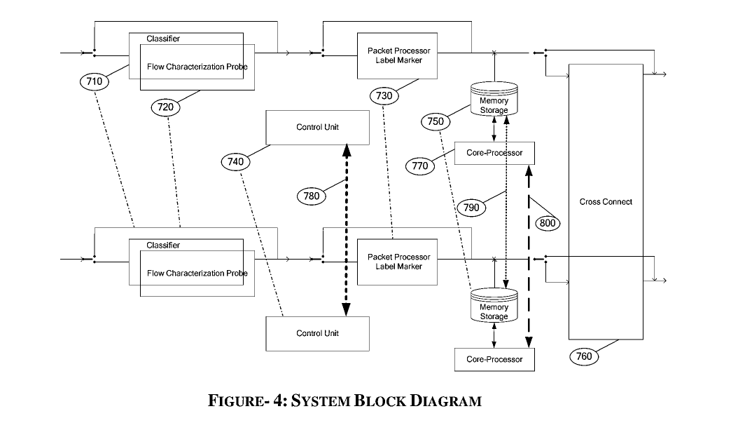

FIG. 4 illustrates a system block diagram 400 in accordance with certain embodiments. As shown, included are classifiers 710, flow characterization probes 720, packet processor label makers 730, memory storages 750, core processors 770, data flows 780 (between control units 740), 790 (between memory storage units 750) and 800 (between core processors 770), and cross connect 760.

In system 400 of FIG. 4, an elasticity probe, for example flow characterization probe 720, monitors the data flow streams passing through the switching fabric, and determines if the flow should be redirected for further processing by the rest of the system. Certain flows are marked as untouched and therefore they are permitted to travel through the fabric uninterrupted for normal switching and routing activities. If the flow is characterized as elastic by the flow characterization probe 720, it will be passed to a classifier 710 for traffic profiling. In another aspect of this system, certain flows may have already been marked as elastic, for example, by source applications or other entities or the like in the path.

In system 400 of FIG. 4, the flow characterization probe 710 and/or flow classifier 720 are responsible for traffic profiling, flow characterization, object identification, file detection and data classification. In addition, it provides the required information for the packet processor 730 and control unit 740. The flow characterization and classifier engines 710, 720 collectively perform hardware speed analysis of flows. This function may further be accelerated through utilizing embedded lookup tables.

In system 400 of FIG. 4, the packet processor (content processor) 730 may modify the packets for the purpose of routing, storing, and discarding according to the control units' 740 instruction sets. In addition, it will add new control labels to the flows for further processing in the system, including by memory 750 and/or a content processor. Also it may perform processing on single packets, such as for example performing CRC (cyclic redundancy check) checking for data integrity and validity. Certain header information may be mapped, marked, extended, time stamped or analyzed for further processing by other sub-systems. The packet processor 730 may provide necessary information to the control unit 740 for further enhanced control procedures.

In system 400 of FIG. 4, the content processor associated with or part of packet processor 730 utilizes multicore processor resources and is responsible for flow content manipulation such as optimization, security enhancement, compression, data mining, analytics, insertion of additional content such as target ads, conversion of content to another format (for example 2D to 3D, AVI to MPEG), packet collection, object mapping and object replacement. It will also perform similar functions on files, APIs, objects, and other flow related interpretations. The content processor may include signature comparisons to enable the system for extended functions such as advanced filtering, substitution, blocking, redirecting, and additional security. From security perspective it will assign signatures to certain objects within the flows to enable addition capabilities in the system. Furthermore, the content processor utilizes the decision lookup table to either push the data into memory and or send to the fabric for switching and forwarding. In another approach, the data may be tagged for future delivery and processing which memory is used for temporary holding of data until the thresholds are met.

In system 400 of FIG. 4, memory storage 750 is responsible for content and packet storage. In addition, all the processing units (for example, content, packet and control) can use the memory blocks for the purpose of providing a temporary location for logical and mathematical functionality.

In system 400 of FIG. 4, cross-connect 760 is for example a circuit-switched network equipment for establishing a dedicated communication channel between network nodes.

In system 400 of FIG. 4, control unit 740 is responsible for all management of identified flows. It may apply additional network level control functions to the flows for the purpose of assignment of additional processing, analytics, resource assignments, scheduling, state association, and classification. State flow association is a function of assignment of proper states to each flow according to a set of actionable assignment through the system. System 400 will assign resources such as memory, power, processing, timers as wells as map flows to a proper state transition class such that a scalable and flexible application of the system can be applied accordingly. Another major function of control unit 740 is flow resource partition estimation according to the flow classifications and the overall system demands. The control unit 740 impacts the flow deliver degree of resource utilization such as memory, time, computing power, and scheduling. In addition, it manages all functional blocks such as the flow characterizer and/or elasticity probe 710, 720, memory 750 and content processor 730. Furthermore, it preforms self-organizing switch functions through communication with other switching systems, such as of kind and/or traditional switches in the system. Elasticity probe 720 may provide status information for control unit 740 for further decision making. Furthermore, the system 400 supports embedded self-flow optimization and control functions, where the control units 740 may further be extended to other nodes and systems to minimize repetition of control function/processing and overhead function/processing. The value of the present approach is obviously great from the point of view of reduction of massive centralized control.

Disclosed herein in certain embodiments is an integrated switching, computing and storage system that provides enhanced switching functions based on multi-dimensional criteria. It partitions specific resources for each flow, and, in reference to the state flow diagram 300, associates appropriate state transition tables to them. The implementation of the present disclosure enables intelligent elastic data delivery diversity which is an enabler for vertical models, including event driven data delivery, trigger based flow forwarding, cloud network optimization, protocol acceleration, data mapping, pre data analytics, data mining, and data filtering. The embodiments enable a front end for the cloud to perform preprocessing and data mining for big data, such as cloud network optimization. In other words, certain embodiments described in the disclosure provide a high performance smart and elastic switching and delivery algorithm at the core. Collectively these functions will reduce the load on the radio resources, cloud servers, and storage related resources. Furthermore, certain embodiments described in the disclosure enable a set of open APIs to enable programmability functions and controls, including at the data, object, file, API and signaling levels.

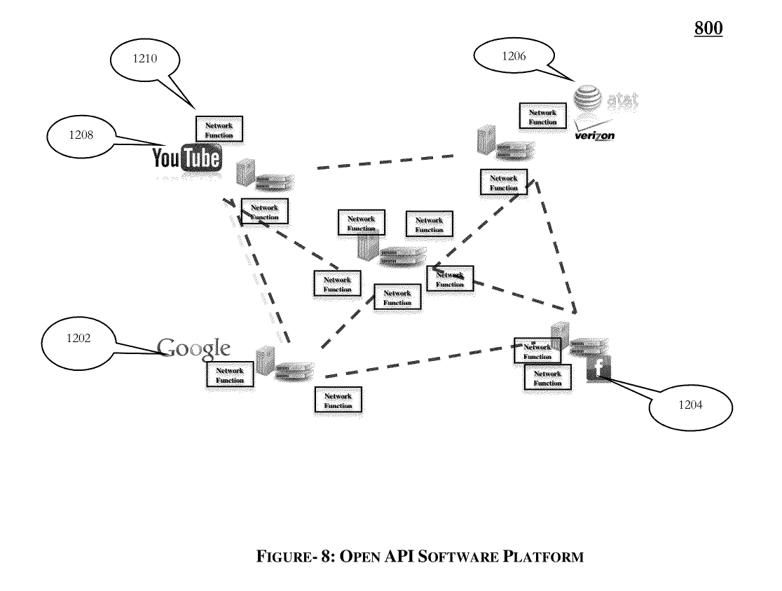

Furthermore, certain embodiments disclosed herein include an open API software platform to enable programmability functions and controls which are enabled by control units and the software parts in different locations of the integrated switching, computing and storage system. This further enables implementing network functions including time shifting, event driven data delivery, trigger based flow forwarding, cloud network optimization, protocol acceleration, data mapping, pre data analytics, data mining, and data filtering. The disclosed API software platform is distributed in the network and cloud and one embodiment is shown in FIG. 8.

System 800 of FIG. 8 is an exemplary API software platform. Illustrated in the network of this system 800 are network operators, including, for example, Google™ 1202, Facebook™ 1204, AT&T™ 1206 and YouTube™ 1208, connected by a vast network comprising hardware/software components having many network functions 1210.

In system 800 of FIG. 8, the API software platform and control units in certain embodiments of the proposed invention enable different network such operators (i.e., Google™ 1202, Facebook™ 1204, AT&T™ 1206 and YouTube™ 1208) to apply additional network level control functions to the flows, among the different network operators, and newly proposed integrated switches in accordance with certain embodiments (either in new integrated switches in their respective facilities or in new integrated switches in the respective networks) for the purpose of assignment of additional processing, analytics, resource assignments, scheduling, state association, and classification. In other embodiments, they enable network function virtualization. The API software platform and control units will also distribute and manage resources, such as memory, power, processing, and timers, in different locations of the network. In one embodiment, it can manage all functional blocks, such as that of the aforementioned flow characterizer, elasticity probe 710/720, memory 750 and content processor 730, and perform self-organizing switch functions through communication with other switching systems of kind and/or traditional switches in the system.

The system will decode IP packets into objects, APIs, files, and or flows for the purpose of further processing, mapping, temporary stores, and analytics. The functional blocks collectively will perform switching, routing, storing, processing at object, API, frame, packet, and file levels. Depending on the flow type, it coordinates proper delivery of content of the flows according to special triggers, either derived from the classifier or look up tables managed by the control unit. Policy tables, control units with the remainder of the functional block, are collectively self-organizing engines.

Therefore, this system is a self-organizing switch which includes an integrated switching fabric with tightly coupled memory, which facilitates network elasticity of networks data flows that are temporarily stored, processed, analyzed, classified, optimized, and/or rerouted. Furthermore, additional pre-processing functions are enabled to reduce overall network load, server loads, and reduce end-to-end delays. This innovative approach enables integration of switching with storage, mobility and cloud optimization.

Traffic flows are characterized, profiled and separated into logical entities in support of emerging markets, including cloud and wireless networks, where they are expected to support billions of connected devices and trillions of sensors. Integration of the computing, networks, and storages are utilized to accelerate data delivery and analysis, cloud expansion and content optimization. The proposed integrated solution provides a new environment where networks can act intelligently to enable new application for network programmability with extended control over the system. Furthermore, this approach extends the current packet switching functions to a new era of packets, objects, APIs, blocks and files, switching at a later time or corresponding to special triggers, events, and instructions with data delivery and optimization considerations.

This innovation extends existing hardware switching to support applications such as Machine-to-Machine optimization, sensor optimization, protocol optimization, cloud optimization, load balancing, wireless and mobility network optimization, and data delivery diversity. Furthermore, this approach enables data traffic aggregation in gateways, such as wireless systems and Machine-to-Machine communication systems.

Data delivery and data store policies are typically determined at the I/O card via a simple look up table. Certain embodiments of this invention enable dynamic flow control for switching, temporary storing and data delivery.

With certain embodiments of this invention the service providers will be able to manage much larger data delivery diversity and traffic management functions, which maps to end-user and application behavior and their capabilities. The receiving servers can influence data delivery time, port, and related polices, including QOS, security, etc., dynamically. As the result, the fabric can maintain non-blocking switching with separation of elastic from inelastic flows.

Optimum delivery of the scalable high demand data traffic is achieved by sending the data based on the destination needs and requirements, when the multidimensional space thresholds are met. In other words, it eliminates the data loss due to non-readiness of the receiver.

Furthermore, certain embodiments of this invention can be placed at the heart of the network, including current switches or at the edge of the network, such as at or with gateways, base stations, and cellular transceiver.

The existing data structure is single layer. Certain embodiments of the invention introduce a new structure for data, as a multi-layer structure, and enable multi-layer data transmissions due to storage and processing capabilities. The single layer data does not have information about the content of the data. Certain embodiments of this invention provide access to specific sections of data. Users/systems can access the data and convert it to a meaningful class, data or subsection thereof, known/identified as layers. An example is an encryption needed-data, and/or an error free transmission specific data needed with a specified error rate (adaptive error rate). In other words, the data within flows are typically single dimensional, as for example, they are of the same format, or are all encrypted, and or are of the same dimension. With the approach provided by certain embodiments of this invention, by way of example, part of the data flow within the same stream (one layer) can be encrypted, another part can be encoded with additional error protection, and another (layer) may be encoded with different codec.

Certain embodiments of the invention enable new long term evolution to current software defined network (SDN) practices where not only the control and switching at L1-L3 are de-coupled, but intelligence, observability, analytics, and delivery diversity are integrated at the switching interconnect level. Certain embodiments of the invention's functional capabilities are built into the emerging fabrics, switches, gateways, base stations, and cross connects, providing tools for the operators to launch advanced services at much lower network utilization.

In one embodiment of the invention the following values in a network of massive flows, such as Internet of things, are enabled: (i) minimizing the amount of time a flow is in “active delivery transit;” (ii) autonomous flow management, less dependency on a synchronized control layer (i.e., less dependency dependent on link discovery/no race conditions); (iii) adjusting the amount of time a flow needs to wait for network access; (iv) minimizing the length of the contention or data loss, and the retransmit ion in the channels; (v) maximizing the network link utilization near the line speed from current practices below 50% utilization; (vi) enabling scalable environment of object switching, object manipulation and flow analytics; and/or (vii) providing comprehensive open APIs to enable programmable service deployments.

In the above embodiment, shown in FIG. 4, the invention includes a switching fabric which passes input flows through the system according to flow policing. The flows are passed through the fabric to output flows or they are stored and processed according to network, user, operator flow policing.

The system consists of multiple input and output ports, multiple boards with hardware and software capabilities, which performs data delivery functions at multiple OSI layers. The system also includes computing power, switching engine, memory/storage, computer boards, chassis, and programmable control functions and interfaces. The system also includes processors for computing, a hardware/software for inter- and intra-control mechanisms, memory for storage, time shifting, processing and analytics, cross connect for switching, and a hardware or software component for marking.

In certain embodiments, an elasticity probe consists of hardware (HW) and/or software (SW) and/or HW/SW co-design, which monitors (i.e., “listens to”) the flow streams passing through the fabric, and detects if the flow should be redirected for further processing by the rest of the system. The hardware can be implemented in an ASIC, an FPGA, and/or a multi-core processor architecture, with internal buffers which establish elasticity for flows passing through. The above described system 400 executes elasticity detection algorithms 710, 720 and communicates with the control unit 740 for further instruction. The elasticity probe may provide status information for the control unit 740 for further decisions.

The control unit 740 can be distributed functional blocks consisting of combinations of hardware and software, which manages all other functional blocks, such as flow characterizer, elasticity probe 710, 720, memory 750 and content processor 730 through an intra-link. Furthermore, control units 740 in different systems communicate among themselves through inter-links, such as by X2 interfaces, wireless means, and fiber optics. It preforms self-organizing switch functions through inter-link connections with other switching systems, which may be of kind and/or traditional and/or open-flow.

Flow Characterization probe/flow classifier 710, 720 includes software level algorithms and methods implemented in dedicated hardware in ASIC, FPGA, multi-core, or hardware/software co-design platforms utilizing processing engines and buffers which performs traffic profiling and traffic function.

Packet Processor 730 is a processing engine in a form of ASIC, FPGA, multi-core, or hardware/software co-design platforms which performs packet header processing. Certain processing functions are executed in hardware/software engine (packet processor) such as CRC check, error correction, marking, header modification, single packet analysis and the like, with control unit status consideration such as network, user, operator, or policy APIs. In addition, packet processors provide necessary information for control unit 740 for further inter-/intra-system management. Control unit 740 may hand over some of the processing and analysis to the content processor 730.

Content Processor 730 is combination of processing functions, memory/buffers and acceleration methods. Its main block utilizes multi-core processor or multi-core DSP processor with programmable instruction sets. The processing engine may be implemented in ASIC, FPGA, and hardware/software co-design.

Memory 750 is combination of solid-state storage, such as SD-RAM, random access memories such as DRAM and processing function for autonomous data delivery functions. The methods of indexing function are accelerated in hardware/software engine. The memory includes all cache-leveled memory and magnetics hard-drive that are distributed or centralized. The memory may be used for header processing, content processing, storage, switching, and/or routing. The memory controller and the memory are controlled by the control unit.

Cross-Connect 760 is a combination of hardware functions such as ASIC, FPGA, shared memory, control tables and software. It can be an existing network switching router.

In another embodiment, the invention can be implemented as an add-on to the traditional switch.

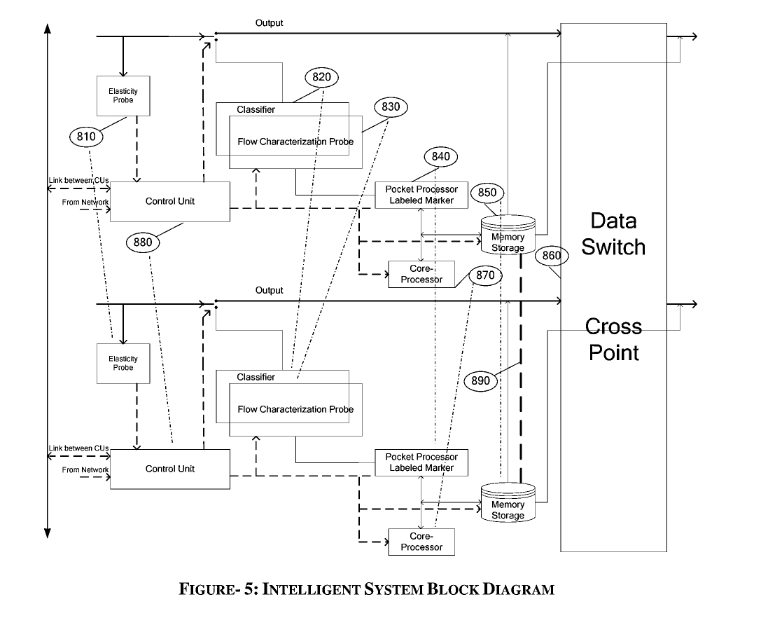

FIG. 5 shows the building diagram of the add-on revision. This implementation is based on an add-on version of certain embodiments of the invention to a current or traditional switch to provide additional processing and diversity delivery.

FIG. 5 provides an intelligent system block diagram 500. As illustrated, system 500 includes elasticity probes 810, control units 880, classifiers 820, flow characterization probes 830, packet processor (labeled markers) 840, core processors 870, memory storage units 850 (with data flow 890) and data switch 860.

he In system 500 of FIG. 5, elasticity probe 810 monitors the flow streams passing through the system, and detects if the flow is elastic or not, and passes this information to the control unit 880, for further processing by the rest of the system. Control unit 880, based on this information in addition to network, user, operator policies and behavior, directs the flow for processing or switching and routing. Therefore, certain flows are marked as untouched by control unit 880 and therefore they travel through the system uninterrupted for normal switching and routing. If the flow is characterized as elastic by control unit 880, it will be passed to classifier 820 for traffic profiling. In another aspect of this system 800, certain flows may already be marked as elastic by the source applications or entities of like in the path.

In system 500 of FIG. 5, the flow characterization probe/flow classifier 830, 820 is responsible for traffic profiling, flow characterization, object identification, file detection plus data classification. In addition, it provides the required information for the packet processor 840. The flow characterization and classifier engines collectively perform hardware speed analysis of flows. This function may further be accelerated through utilizing embedded lookup tables.

In system 500 of FIG. 5, the packet processor 840 positions the packets for the purpose of routing, storing, and discarding according to the control units' 880 instruction sets. In addition, it will add new instruction sets to the flows for further processing in the system including memory and/or content processor. Also it may perform processing on single packets such as CRC checking for data integrity and validity. Certain header information may be mapped, marked, extended, time stamped or analyzed for further processing by other sub-systems. The packet processor may provide necessary information to the control unit for further enhanced control procedures.

In system 500 of FIG. 5, the content processor utilizes multicore processor resources and is responsible for flow content manipulation such as optimization, security enhancement, compression, data mining, analytics, insertion of additional content such as target ads, conversion of content to another format (for example 2D to 3D, avi to mpeg4), packet collection, object mapping and object replacement. It will also perform similar functions on files, APIs, objects, and other flow related interpretations. The content processor may include signature comparisons to enable the system for extended functions such as advanced filtering, substitution, blocking, redirecting, and additional security. From security perspectives, it will assign signatures to certain objects within the flows to enable addition capabilities in the system. Furthermore, the content processor utilizes the decision lookup table to either push the data into memory and or send to the fabric for switching and forwarding. In another approach, the data may be tagged for future delivery and processing which memory is used for temporary holding of data until the thresholds are met.

The system of FIG. 5, control unit manages all functional blocks such as flow characterizer, elasticity probe, memory and content processor. Furthermore, it preforms self-organizing switch functions through communication with other switching systems of kind and/or traditional switches in the system. Elasticity probe may provide status information for control unit for further decisions. In addition, the system of FIG. 5, control unit is responsible for all management of identified flows, where it applies additional network level control functions to the flows for purpose of assignment of additional processing, analytics, resource assignments, scheduling, state association, and classification. State flow association is a function of assignment of proper states to each flow according to a set of actionable assignment through the system. The system will assign resources such as memory, power, processing, timers as wells as it will map flows to proper state transition classes such that a scalable and flexible application of the system can be applied accordingly. Another major function of control unit is flow resource partition estimation according to the flow classifications and the overall system demands. The control unit impacts the flow delivery degree of resource utilization such as memory, time, computing power, and scheduling. The system supports embedded self-flow optimization and control functions, where the control units further may be extend to other nodes and system to minimize repetition of control and overheads. The value of this approach is obvious from reduction of massive centralized control.

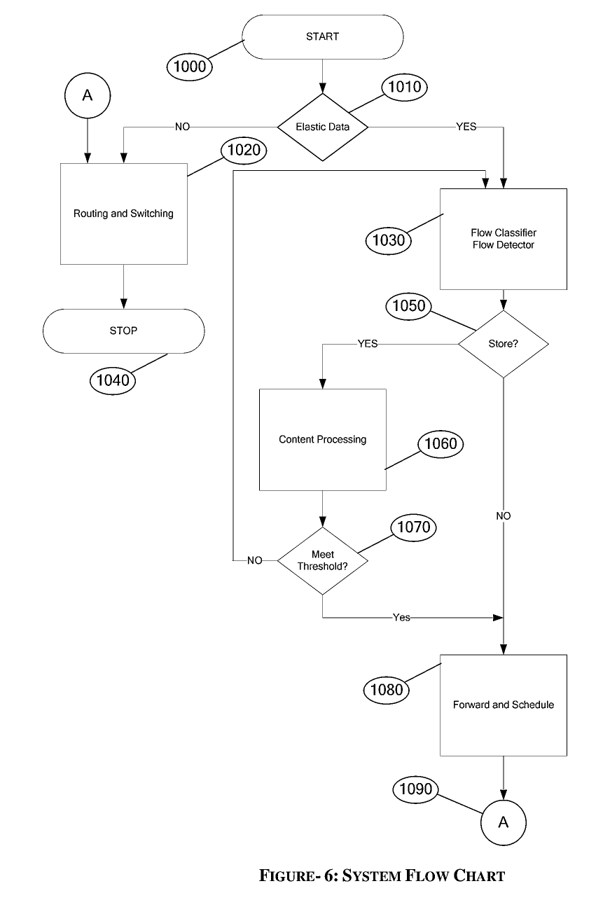

FIG. 6 illustrates an example of a flow diagram showing how different blocks in add-on implementation work with each other and how the flows pass through this system. The steps include start 1000, determination of whether the data is elastic 1010. If not, routing and switching is performed in step 1020, and control stops at 1040. If the data is elastic in step 1010, the flow classifier/flow detector functions in step 1030, and storage is determined in step 1050, where if the answer is yes, content processing is performed in step 1060, and if no, control passes to step 1080, where forwarding and scheduling is performed, with control passing thereafter to step 1090, which returns control to step 1020, namely routing and switching. In addition, upon content processing in step 1060, it is determined whether the threshold has been met in step 1070, where if the answer is no, control returns to step 1030, and if yes, control passes to step 1080, as above noted.

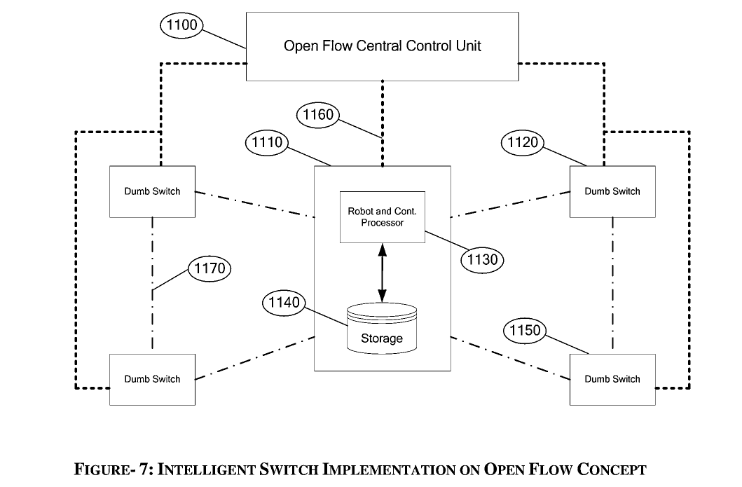

In another embodiment, shown as system 700 of FIG. 7 is an intelligent switch implementation on the open flow concept. In certain embodiments, the invention can be realized in a software-defined-network architecture as shown. As illustrated, system 700 includes open flow central control unit 1100, dumb switches 1120, 1150 (not labeled on the left hand side), data flow between the dumb switches (not labeled on the right hand side), system 1110 (including robot and cont. processor 1130, and storage 1140), and data flow 1160 between item 1100 and 1110.

This implementation, shown in FIG. 7, is based on enabling certain embodiments of the invention based on virtualized switches, like Open Flow to provide additional processing and diversity delivery. This system is similar to what described in the above implementation of system 400. However, here the system in the implementation of FIG. 4 has been implemented in a distributed fashion.

In the system of FIG. 7, open flow controller 1100 can take the responsibility of the control unit in implementation of certain embodiments of the proposed invention. Additional functionalities in certain embodiments of the proposed invention can be added to the controller in the Open Flow implementation. In different places, in network between traditional switches that can be controlled by Open Flow, a content processor robot with integrated storage is provided to enable additional processing and data delivery for the systems based on distributed virtualization switching.

Certain embodiments of this invention can be used to complement existing traditional networks while it is design for SDN such as Open flow environment, which exhibit a number of new capabilities, e.g. matching on multidimensional fields to detect “Objects”, policy driven dynamic-functional parsing for delivery diversity and time shifting, provides APIs for analytics computing and flow aggregation for synch services and just on time delivery of flows to match the servers, storage and rest of network readiness to accept a flow. For example, it parks the flows in dormant states to coordinate proper delivery in synch with network, computing and storage entities.

In certain embodiments, the invention's differentiation begins with the development of the open APIs for massive programmability of a high performance switch fabric functions blocks which are embedded as core functions into the multi-dimensional delivery fabrics.

The open API software platform provides processing, storage and control programmability to the system.

In certain embodiments of the invention, the programming models are super set of SDN where the based delivery engine are based on both embedded and control layer tags, policies, triggers, events, and real time analytics performed on the flow characteristics.

The goal of certain embodiments of this invention is not only to develop a new model which is appropriate for modern SDN control stacks, but also provide a rich set of tools in support of emerging sensory, education, cloud, and eHealth platforms and services. The collective outcomes are separate thrusts including abstraction of rich switching, computing, and analytics functions to enable diversified flow management options.

Networking companies including operators, Internet related products and service providers (such as Google, Yahoo, Amazon), cable companies (such as Comcast, Verizon), broadcast companies (such as Netflix), wireless and cellular providers (such as Verizon), content providers (such as YouTube), data centers and analytic companies (such as ByteMobile, Google), online storage providers (such as Dropbox), social networking service providers (Facebook, LinkedIn), online shopping websites (eBay, Amazon), Education providers (such as desire2learn), eHealth industries (such as doximiti), Information providers (such as BBC), and many others, can each utilize certain embodiments of this invention for the purpose of data delivery diversity, optimization, analytics, flow scheduling, time shifting, resource forecasting, event delivery, content processing, data mining, object switching, API switching, intelligent processing function, emergency, security, load balancing, tire pricing, according to collective policies, and available resources.

Applications of this innovation are described for various vertical markets such as data server optimization, network optimization, data delivery diversity, intelligent data mining/mapping, front-end to cloud and data center, mobile delivery relay for cellular networks.

In one embodiment, the cloud based platforms shift certain functions such as load balancing to the core networks. In this innovation, the flows not only are delayed until servers are ready, but are also redirected to the appropriate cloud servers based on the specific policies and controls.

In another embodiment, for M2Mapplications, the M2M flows are aggregated at the network until certain delivery thresholds are met.

In another embodiment, certain content within flows such as identifiable objects can be mapped to another content type or object. For example the network with capabilities of certain embodiments of this invention may perform object mapping based on control layer policies set for the specific flows. Specifically, for example, harsh pictures/objects within a flow or stream can be replaced with more sensible object.

In another embodiment, the delivery of certain flow events can be delayed until the receiver is ready for processing. In other words certain receivers processing capabilities may be limited-to-limited resource power and therefore the tasks can be queued inside the core network instead.

In another embodiment, flows with lots of raw data can be mapped to flows with specific knowledge where the analytics engine at the core network will convert the raw data into knowledge.

What is claimed is:

1- A novel self-organizing data processor & delivery fabric that facilitates switching, routing, data delivery diversity at multi-disciplinary levels and pre-delivery content processing. It enables adaptive flow handling, where flows are characterized and switched at multi-discipline policies influencing on the fly for analytics, computing and storage delivery. It enables packet/trigger/API/object/event/policy routing, switching, protocol, data and signaling optimization, aggregation, and mapping functions at packet, object, block, and file level comprising: a processor configured to execute a set of computer-readable instructions; a memory component coupled to the switching fabrics and configured to store the set data flows in the integrated memory with the switching fabric until at least one algorithm or data delivery “labeled marking” is analyzed and/or data content is processed for determining the delivery methodology including format, time, location, etc. to assist scheduling algorithms.

2- The method of claim 1, the memory integrated component of switching fabric further configured to store a set of delay insensitive, near real-time, and real-time data, the at least one algorithm for determining scheduling of data stored for delivery dependent on the set of triggers, events, and policies based on delivery “labeled marking” where delivery “labeled marking” may further contain delivery function, instruction to the fabric, etc.

3- The method of claim 1, where the data processing element will take place on the data stored in memory to perform functions of the proposed system including packet routing, switching, protocol, data and signaling optimization, aggregation, mapping functions at packet, object, block, and file level, and specific processing functions such as those specific to the cloud servers, here, known as pre-delivery data processing functions.

4- The method of claim 1, where the memory is integral part of the switching fabric for purpose of object switching, object store and data delivery diversity based on multi-dimensional delivery “labeled marking”, where the memory is tightly coupled with the switching fabric for optimum performance gain.

5- The method of claim 1, the fabric attached memory is partitioned in such a way for optimum delay IOP, at block, file, object, packet associated with different data types including sensor data with variant QOS with multi-dimensional delivery “labeled marking” for specific preferences corresponding to the end user, network and content data delivery polices.

6- The method of claim 1, where classification probe, packet processor and content processor are used to extract objects and subsets of objects from the raw packets. Classified objects will carry out based on multi-dimensional delivery key performance metrics, including network, users, and content provider's conditions.

7- The method of claim 1, where a set of “labeled marking” flow is generated based on classification output and network conditions including QOS and with specific preferences corresponding to the end user, network and content data by the data delivery engine which are used to separate packets from objects, and objects from control sensors, or storing certain data flows for further processing or data delivery diversity with special preferences corresponding to an enterprise.

8- The method of claim 1, the set of switching functions may include data store functions at the integrated memory fabric until appropriate thresholds are met for appropriate triggering for switching and data delivery over the fabric ports.

9- The method of claim 1, where a packet/flow processor generates “labeled marking” based on network, users, and content provider's policies.

10- The method of claim 1, the set of switching methodology beyond packet switching including API, object, file, block switching at network conditions at a given time. Further comprising receiving data and converting the data into different format for switching at desired level (packet, object, block, file, API). Further comprising the system enabling customized knowledge switching, where the knowledge defines by the policy function.

11- The method of claim 1, the interface component of switching fabric configured to receive packets, objects, files, blocks and utilize the fabric memory for further translation to another switching method or simply keep the same switching method with consideration for delivery tied to “labeled marking” label.

12- The method of claim 1, a method for facilitating management of elastic data in a cloud/enterprise or wireless environment, comprising: with a degree of elasticity to eliminate unnecessary delivery of data over network infrastructure and scheduling a transmission of traffic entities including in and out of memory stored fabric with particular degree of QOS which includes data delivery conditions such as receivers triggers, events, and or networks congestion level corresponding to the particular flow.

13- The method of claim 1, further comprising ascertaining a set of tolerance data, the scheduling step at least partially dependent on the network condition, protocol, servers, load balancing, shaping, and traffic pacing.

14- The method of claim 1, further comprising a an inter/intra interaction communication interface among system of claim 1, enterprise, other proposed system and/or internet nodes to acquires conditional synch delivery to form a self-organized distributed intelligent and collaborative delivery fabric.

15- The method of claim 1, inter/intra interaction communication comprising signaling, control, system conditions, states, server loads, memory thresholds and content providers. where it further comprising ascertaining data delivery options mapping each of the flows to an appropriate lookup table known as fabric key performance indicators.

16- The method of claim 1, where the fabric key performance indicators are utilized to make scheduling and content processing decisions. Further comprising the scheduler can function at resource blocks associated with the next switching hub corresponding to a similar or reduce functions with respect to object, block, API, and packet switching level capabilities.

17- The method of claim 1, the assembling step further comprises characterizing each of the delivered traffic entities where the characteristic of switching depends on schedulers directives and look up policy tables.

18- The method of claim 1, further comprising transmitting data in and out of fabric which includes instruction for next hub delivery indicating at least one port or memory location for the data forwarding.

19- The method of claim 1, provides self-organizing emergency response system through enablement of elastic buffer for store and forward function plus received broadcast of emergency signal at the state of emergency, where the potentially network relationships are at high risk or totally lost, mesh and . . . .

20- The method of claim 1, the flows within each system are power and resource optimized through state transitions. Certain or all the flows are controlled by control units through state transitions such as idle, connected, wait state, pending, etc. to enable fully or partially functioning such as processing, mapping, routing, storing, . . . .
